(19) United States
(12) Patent Application Publication
(10) Pub. No.: US 2015/0059483 A1
(43) Pub. Date: Mar. 5, 2015

(54) SENSORS FOR MEASURING AT LEAST ONE OF PRESSURE AND TEMPERATURE, AND RELATED ASSEMBLIES AND METHODS

(71) Applicant: Delaware Capital Formation, Inc., Wilmington, DE (US)

(72) Inventors: Derek W. Puccio, Salt Lake City, UT (US); Shane D. Rose, West Jordan, UT (US)

(21) Appl. No.: 14/472,218

(22) Filed: Aug. 28, 2014

Related U.S. Application Data
(60) Provisional application No. 61/873,149, filed on Sep. 3, 2013.

(51) Int. Cl. G01L 9/00; G01L 19/00

(52) U.S. Cl. CPC G01L 9/0022; G01L 19/0092
USPC 73/702

(57) ABSTRACT

Thickness shear mode resonator pressure sensors include a housing having an outer dimension that is less than 0.575 inch (14.605 millimeters). Pressure transducers may include a quartz pressure sensor and a quartz reference sensor, wherein an electronics assembly of the pressure transducer is configured to drive at least one of the quartz pressure sensor and the quartz reference sensor at a frequency greater than 10 MHz. Transducer assemblies include an electronics assembly configured to drive at least one quartz sensor of the transducer assembly at a frequency greater than 10 MHz.

### CROSS REFERENCE TO RELATED APPLICATION

This application claims the benefit of U.S. Provisional Patent Application Ser. No. 61/873,149, filed Sep. 3, 2013 entitled “SENSORS FOR MEASURING AT LEAST ONE OF PRESSURE AND TEMPERATURE, AND RELATED ASSEMBLIES AND METHODS,” the disclosure of which is incorporated herein by reference in its entirety.

### TECHNICAL FIELD

Embodiments of the present disclosure relate to sensors for measurement of at least one of a pressure and temperature and, more particularly, to quartz resonator sensors for measurement of at least one of a pressure and temperature and related assemblies and associated methods.

### BACKGROUND

Thickness shear mode quartz resonator sensors have been used successfully in the downhole environment of oil and gas wells for several decades and are an accurate means of determining downhole pressures in widespread use in hydrocarbon (e.g., oil and gas) exploration and production, as well as in other downhole applications. Quartz resonator pressure sensors typically have a crystal resonator located inside a housing exposed to ambient bottom-hole fluid pressure and temperature. Electrodes on the resonator element coupled to a high frequency power source drive the resonator and result in shear deformation of the crystal resonator. The electrodes also detect the resonator response to pressure and temperature and are electrically coupled to conductors extending to associated power and processing electronics isolated from the ambient environment. Ambient pressure and temperature are transmitted to the resonator, via a substantially incompressible fluid within the housing, and changes in the resonator frequency response are sensed and used to determine the pressure and/or temperature and interpret changes in same. For example, a quartz resonator sensor, as disclosed in U.S. Pat. Nos. 3,561,832 and 3,617,780, includes a cylindrical design with the resonator formed in a unitary fashion in a single piece of quartz. End caps of quartz are attached to close the structure.

Generally, a pressure transducer comprising a thickness shear mode quartz resonator sensor assembly may include a first sensor in the form of a primarily pressure sensitive thickness shear mode quartz crystal resonator exposed to ambient pressure and temperature, a second sensor in the form of a temperature sensitive quartz crystal resonator exposed only to ambient temperature, a third reference crystal in the form of quartz crystal resonator exposed only to ambient temperature, and supporting electronics. The first sensor changes frequency in response to changes in applied external pressure and temperature with a major response component being related to pressure changes, while the output frequency of the second sensor is used to temperature compensate temperature-induced frequency excursions in the first sensor. The reference crystal, if used, generates a reference signal, which is only slightly temperature-dependent, against or relative to which the pressure- and temperature-induced frequency changes in the first sensor and the temperature-induced frequency changes in the second sensor can be compared. Such comparison may be achieved by, for example, frequency mixing frequency signals and using the reference frequency to count the signals from the first and second sensors for frequency measurement.

Prior art devices of the type referenced above including one or more thickness shear mode quartz resonator sensors exhibit a high degree of accuracy even when implemented in an environment such as a downhole environment exhibiting high pressures and temperatures. However, each of the quartz resonator sensors that are included in a pressure transducer may be relatively expensive to fabricate, as each quartz resonator sensor must be individually manufactured. Further, the size of the housing required to carry the sensor assembly may be dictated by the desired frequency output of the resonator of each quartz resonator sensor of the assembly. The overall size and positioning requirements of each of such quartz resonator sensor in a pressure transducer may limit the size, shape, and configuration of the assembly, which is usually of significant concern given size constraints imposed by inner diameters of drill string and production string tubular components in which the sensor assembly may be disposed. Furthermore, the size of each of such quartz resonator sensors and the resonating portion thereof will affect the speed and accuracy with which the sensor adjusts to changes in pressure and/or temperature and how quickly the sensor can reach thermal equilibrium.

### BRIEF SUMMARY

In some embodiments, the present disclosure includes a thickness shear mode resonator pressure sensor. The thickness shear mode resonator pressure sensor includes a housing having a longitudinal axis. The housing includes a resonator having a resonating portion, a first end cap forming first recess between a first side of the resonating portion of the resonator and the first end cap, and a second end cap forming second recess between a second side of the resonating portion of the resonator and the first end cap. An outer dimension of the housing taken in direction transverse the longitudinal axis of the housing may be less than 0.575 inch (14.605 millimeters).

In additional embodiments, the present disclosure includes a quartz resonator pressure transducer assembly. The quartz resonator pressure transducer assembly includes a pressure housing comprising at least one chamber, an electronics housing comprising an electronics assembly, and a quartz pressure sensor in communication with the at least one chamber and for measuring pressure of a fluid disposed within the at least one chamber. The electronics assembly is configured to drive the quartz pressure sensor at a selected frequency and to sense a pressure-related frequency response from the quartz pressure sensor. The quartz resonator pressure transducer assembly further includes a quartz reference sensor where the electronics assembly is configured to drive the quartz reference sensor at a selected frequency and to sense a reference frequency response from the quartz reference sensor. The electronics assembly may be configured to drive at least one of the quartz pressure sensor and the quartz reference sensor at a frequency greater than 10 MHz.

In additional embodiments, the present disclosure includes a quartz resonator pressure transducer assembly. The quartz resonator pressure transducer assembly includes a pressure housing comprising at least one chamber, an electronics housing comprising an electronics assembly, and a quartz pressure sensor in communication with the at least one chamber and for measuring pressure of a fluid disposed within the at least one chamber. The electronics assembly is configured to drive the quartz pressure sensor at a selected frequency and to sense a pressure-related frequency response from the quartz pressure sensor. An outer dimension of the pressure transducer assembly is less than 0.75 inch (19.05 millimeters).

In yet additional embodiments, the present disclosure includes a transducer assembly including an electronics assembly configured to drive at least one quartz sensor of the transducer assembly at a frequency greater than 10 MHz.

In yet additional embodiments, the present disclosure includes sensors and related assemblies and methods of forming and operating sensors and related assemblies as described below.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure provided with reference to the accompanying drawings, in which:

FIG. 1 is a partial cross-sectional view of a transducer in accordance with an embodiment of the present disclosure;

FIG. 2 is a perspective view of sensor in accordance with an embodiment of the present disclosure;

FIG. 3 is a cross-sectional side view of the resonator sensor shown in FIG. 1;

FIG. 4 is a simplified schematic block diagram of a circuit suitable for use with sensors and transducer assemblies according to an embodiment of the present disclosure.

FIG. 5 is a simplified schematic block diagram of another circuit suitable for use with sensors and transducer assemblies according to an embodiment of the present disclosure.

FIG. 6 is a simplified schematic block diagram of yet another circuit suitable for use with sensors and transducer assemblies according to an embodiment of the present disclosure.

FIG. 7 is a simplified schematic block diagram of yet another circuit suitable for use with sensors and transducer assemblies according to an embodiment of the present disclosure.

FIG. 8 is a simplified schematic block diagram of yet another circuit suitable for use with sensors and transducer assemblies according to an embodiment of the present disclosure.

### DETAILED DESCRIPTION

In the following detailed description, reference is made to the accompanying drawings that depict, by way of illustration, specific embodiments in which the disclosure may be practiced. However, other embodiments may be utilized, and structural, logical, and configurational changes may be made without departing from the scope of the disclosure. The illustrations presented herein are not meant to be actual views of any particular sensor, transducer, or component thereof, but are merely idealized representations that are employed to describe embodiments of the present disclosure. The drawings presented herein are not necessarily drawn to scale. Additionally, elements common between drawings may retain the same numerical designation.

Although some embodiments of sensors of the present disclosure are depicted as being used and employed in pressure transducer assemblies, persons of ordinary skill in the art will understand that the embodiments of the present disclosure may be employed in any assembly or system for measurement of at least one of pressure and temperature with a quartz resonator sensor.

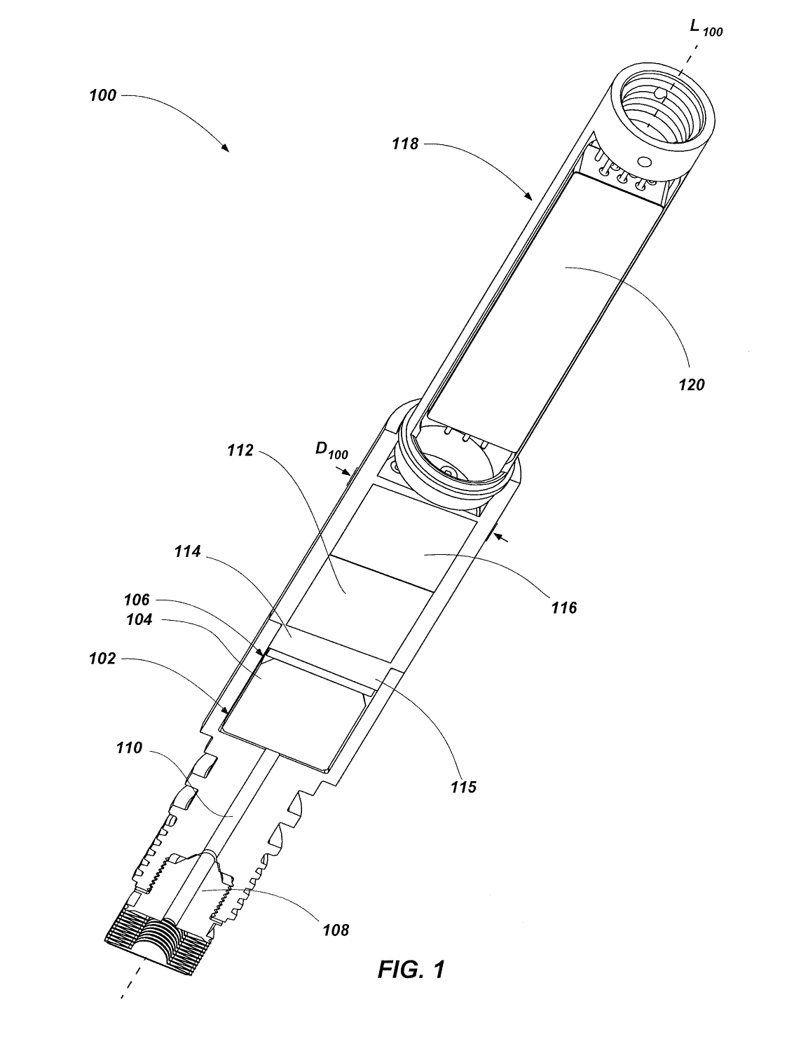

FIG. 1 is a perspective view of a pressure transducer 100 including one or more sensors. As shown in FIG. 1, the pressure transducer 100 may include a pressure housing 102 having a pressure sensor 104 disposed in a chamber 106 in the pressure housing 102. The chamber 106 in the pressure housing 102 may be in communication with an environment exterior to the pressure transducer 100 in order to determine one or more environmental conditions in the exterior environments (e.g., a pressure and/or temperature of the exterior environment). For example, the chamber 106 may be in fluid communication with an isolation element 108 (e.g., a diaphragm assembly, a bladder assembly, a bellows assembly, as well as combinations of the foregoing). The isolation element 108 may act to transmit pressure and/or temperature exterior to the pressure transducer 100 to sensors within the pressure transducer 100 (e.g., via a fluid within the pressure transducer). The chamber 106 in the pressure housing 102 may be in fluid communication with isolation element 108 (e.g., via channel 110). Fluid may be disposed in the chamber 106 around the pressure sensor 104, in the channel 110, and in the isolation element 108 to transmit the pressure and/or temperature from the exterior of the pressure transducer 100. In some embodiments, the fluid within pressure transducer 100 may comprise a highly incompressible, low thermal expansion fluid such as, for example, oil (e.g., a Paratherm or sebacate oil). The pressure and thermal expansion of the fluid may be sensed by the pressure sensor 104 (e.g., a quartz crystal sensing element).

As further depicted in FIG. 1, the pressure transducer 100 may include one or more additional sensors that are utilized along with the pressure sensor 104 to determine and compensate for environmental conditions affecting output of the pressure sensor 104, as well as providing a reference signal. The pressure transducer 100 may include a temperature sensor 112 that is at least partially isolated from (e.g., by a pressure feedthrough portion 114 that includes bulkhead 115) from the fluid within the pressure housing 102 that is in communication with the exterior environment. The temperature sensor 112 is utilized to sense the temperature of the exterior environment (e.g., as is it transmitted to temperature sensor 112 through the housing of the pressure transducer 100) to enable compensation for temperature-induced inaccuracies in the output of pressure sensor 104.

In some embodiments, the pressure transducer 100 may include a reference sensor 116 that is isolated from (e.g., by the pressure bulkhead 115) from the fluid within the pressure housing 102 that is in communication with the exterior environment. As known in the art, an output of such a references sensor 116 may be utilized for comparison with other sensors (e.g., the pressure sensor 104, the temperature sensor 112, or combinations thereof). It is noted that while the embodiment of FIG. 1 illustrates the temperature sensor 112 being positioned relatively closer to the pressure sensor 104 than the reference sensor 118, in other embodiments, the reference sensor 118 may be positioned relatively closer to the pressure sensor 104 than temperature sensor 112.

As depicted in the FIG. 1, each of the sensors 104, 112, 118 may be positioned along a longitudinal axis L₁₀₀ of the pressure transducer 100. For example, the sensors 104, 112, 118 may be positioned in-line along the longitudinal axis L₁₀₀ of the pressure transducer 100.

As discussed below in further detail, the pressure sensor 104 may have an outer dimension (e.g., diameter) that is less than conventional pressure sensors (e.g., conventional quartz pressure resonator sensors). For example, some conventional pressure sensors have an outer dimension of about 0.575 inch (14.605 millimeters). The pressure sensor 104 may have an outer dimension less than 0.575 inch (14.605 millimeters) (e.g., about 0.375 inch (9.525 millimeters)). Such a pressure sensor 104 may enable the size of the pressure transducer 100 to be reduced. For example, the pressure transducer 100 may have an outer dimension D₁₀₀ (e.g., a maximum outer dimension such as an outer diameter) taken in a direction transverse to the longitudinal axis L₁₀₀ of the pressure transducer 100 that is less than conventional pressure transducer (e.g., conventional pressure transducer utilizing quartz resonator sensors). For example, some conventional pressure transducers have an outer dimension of about 0.75 inch (19.05 millimeters). The pressure sensor 104 may have an outer dimension less than 0.75 inch (19.05 millimeters). For example, the outer dimension D₁₀₀ of the pressure transducer 100 may be less than 0.70 inch (17.78 millimeters), less than 0.60 inch (15.24 millimeters), less than 0.50 inch (12.7 millimeters), or lower. By way of further example, the outer dimension D₁₀₀ of the pressure transducer 100 may be between about 0.40 inch (10.16 millimeters) and 0.60 inch (15.24 millimeters) (e.g., about 0.50 inch (12.7 millimeters)).

An electronics housing 118 is coupled to the pressure housing 102. As depicted, the electronics housing 118 include an electronics assembly 120 that is at least partially isolated from the fluid within the pressure housing 102 that is in communication with the exterior environment. The electronics assembly 120 may be electrically coupled to each of the sensors 104, 112, 116 in the pressure transducer 100 (e.g., via electrical feedthrough pins (not shown)) and may be utilized to operate (e.g., drive) one or more of the sensors 104, 112, 116 and to receive the output of the sensors 104, 112, 116.

In some embodiments, pressure transducers in accordance with the instant disclosure may include methods of fabrication, orientations, quartz structures, electronics, assemblies, housings, reference sensors, and components similar to the sensors and transducers disclosed in, for example, U.S. Pat. No. 6,131,462 to EerNisse et al., U.S. Pat. No. 5,471,882 to Wiggins, U.S. Pat. No. 5,231,880 to Ward et al., U.S. Pat. No. 4,550,610 to EerNisse et al., and U.S. Pat. No. 3,561,832 to Karrer et al., the disclosure of each of which patents is hereby incorporated herein in its entirety by this reference.

As mentioned above, pressure sensor 104 may comprise a quartz crystal sensing element. In some embodiments, a pressure transducer having a quartz crystal pressure sensor (e.g., such as that described in U.S. Pat. No. 6,131,462 to EerNisse et al.) will also include a quartz crystal reference sensor 116 and a quartz crystal temperature sensor 112 that are utilized in comparing the outputs of the crystal sensors (e.g., via frequency mixing and/or using the reference frequency to count the signals from the other two crystals) for temperature compensation and to prevent drift and other pressure signal output anomalies. In other embodiments, one or more of the sensors (e.g., the temperature sensor 112) may comprise an electronic sensor (e.g., a silicon temperature sensor using, for example, integrated electronic circuits to monitor temperature rather than a sensor exhibiting temperature-dependent variable mechanical characteristics (e.g., frequency changes of a resonator element) such as a quartz crystal resonator). For example, the sensor configurations may be similar to those described in U.S. patent application Ser. No. 13/934,058, filed Jul. 2, 2013, the disclosure of which is hereby incorporated herein in its entirety by this reference, which application describes the use of an electronic temperature sensor in a pressure transducer.

In yet additional embodiments, the pressure sensor 104 may comprise a dual-mode sensor configured to sense both pressure and temperature, for example, such as those described in U.S. patent application Ser. No. 13/839,238, filed Mar. 15, 2013, the disclosure of which is hereby incorporated herein in its entirety by this reference.

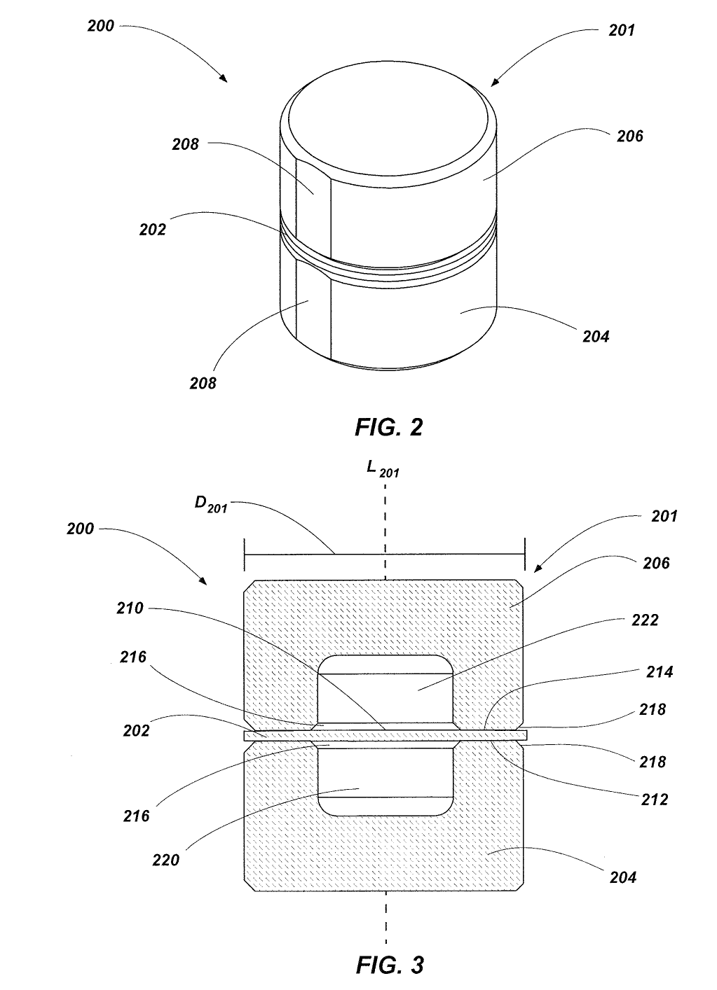

FIG. 2 is a perspective view of a resonator sensor 200 (e.g., a quartz resonator sensor) that may be utilized in a transducer assembly (e.g., pressure transducer 100) to sense one of pressure and temperature. For example, one or more of the sensors 104, 112, 116 discussed above with reference to FIG. 1, may be formed as sensor 200.

As shown in FIG. 2, the quartz resonator sensor 200 includes a resonator element 202 at least partially disposed in a housing 201. A portion of the resonator element 202 may be bounded on sides thereof. For example, the housing 201 may include two end caps (e.g., a first end cap 204 end and a second end cap 206) and the resonator element 202 may disposed between the end caps 204, 206 to form the housing 201. In some embodiments, each of the end caps 204, 206 includes a flat 208 to facilitate alignment (e.g., alignment of the orientation of the quartz crystal) of the end caps 204, 206 during assembly of the resonator sensor 200.

In some embodiments, one or more components of resonator sensor 200 may be fabricated from single crystal quartz, for example, from quartz plates cut to exhibit an AT-cut, BT-cut, or other suitable orientation. For example, the resonator sensor 200 may be formed as a thickness-shear-mode quartz resonator element 202 with two quartz end caps 204, 206, each component being formed from quartz plates (e.g., AT-cut quartz plates).

FIG. 3 is a cross-sectional side view of the resonator sensor 200. As shown in FIG. 3, the end caps 204, 206 may be coupled to the resonator element 202 at joints 212, 214 (e.g., butt joints) by, for example, an adhesive or bonding process (e.g., a fused glass frit). Each of the end caps 204, 206 may include one or more chamfers (e.g., an inner diameter chamfer 216 and an out diameter chamfer 218 proximate (e.g., at) the joints 212, 214 between the end caps 204, 206 and the resonator element 202.

The resonator element 202 may include a resonating portion 210 that is enabled to resonate freely (e.g., displace, vibrate, etc.) when driven or forced (e.g., driven by electrodes (not shown) formed on the resonator element 202) at one or more selected frequencies by driving electronics (e.g., driving electronics of the electronics assembly 120 (FIG. 1)). For example, a recessed portion 220 in the end cap 204 and another recessed portion 222 in the end cap 206 may enable the resonating portion 210 of the resonator element 202 to resonate within the housing 201 of the resonator sensor 200. In some embodiments, one or more recessed portions may be formed as part of the resonator element 202 (e.g., in addition to or in place of the recessed portions 220, 222 in the end caps 204, 206) to enable the resonating portion 210 of the resonator element 202 to resonate within the housing 201 of the resonator sensor 200.

In some embodiments, the recessed portion 220 of the end cap 204 may be substantially aligned with the recessed portion 222 of the end cap 206 such that each point on the outer boundary of the recessed portion 220 is substantially collinear to a similar point of the recessed portion 222.

The housing 201 of the resonator sensor 200 has a longitudinal axis L₂₀₁ extending through both the end caps 204, 206 and the resonating portion 210 along the length of the resonator sensor 200.

Referring still to FIG. 3, the resonating portion 210 may have a rounded shape (e.g., a bi-convex resonator). In other embodiments, a resonating portion 210 or a portion thereof may comprise other shapes such as, for example, piano-piano, plano-convex, etc. In some embodiments, the outer portion of the resonator element 202 surrounding the resonating portion 210 may be substantially flat to enable coupling to the end caps 204, 206.

As depicted, the resonator sensor 200 (e.g., the housing 201) has an outer dimension D₂₀₁ (e.g., a maximum outer dimension such as an outer diameter) taken in a direction transverse (e.g., perpendicular) to the longitudinal axis L₂₀₁ of the housing 201 that may be less than the outer dimension of conventional resonator sensors. For example, some conventional resonator sensors have an outer dimension of about 0.575 inch (14.605 millimeters). Resonator sensor 200 has outer dimension D₂₀₁ less than about 0.575 inch (14.605 millimeters). For example, outer dimension D₂₀₁ of the resonator sensor 200 may be about 0.50 inch (12.7 millimeters), 0.40 inch (10.16 millimeters), or lower, such as, for example, about 65% of the size of a conventional resonator sensor (e.g., 0.375 inch (9.525 millimeters)). By way of further example, the outer dimension D₂₀₁ of the resonator sensor 200 may be between about 0.30 inch (7.62 millimeters) and about 0.50 inch (12.7 millimeters) or between about 0.30 inch (7.62 millimeters) and about 0.40 inch (10.16 millimeters).

In some embodiments, the resonator sensor 200 (e.g., a pressure resonator sensor) may have a similar size to another sensor in a transducer (e.g., one or more of the temperature sensor 112 and the reference sensor 116 of pressure transducer 100 discussed above with reference to FIG. 1). For example, the outer dimension D₂₀₁ of the resonator sensor 200 may be within plus or minus twenty-five percent (±25%), plus or minus ten percent (±10%), plus or minus five percent (±5%), or lower (e.g., substantially equal) of a maximum outer dimension of another sensor in the same transducer.

In some embodiments, the relatively smaller resonator element 202 of the resonator sensor 200 may resonate at a frequency about one and half times (1.5×), two times (2×), three times (3×), or greater than conventional sensors. For example, the relatively smaller resonator element 202 of the resonator sensor 200 may resonate at over 10 MHz, over 14 MHz (e.g., 14.4 MHz), or over 21 MHz (e.g., 21.6 MHz), which is about one and half times, two, or three times the frequency of about 7.2 MHz of a conventional sensor.

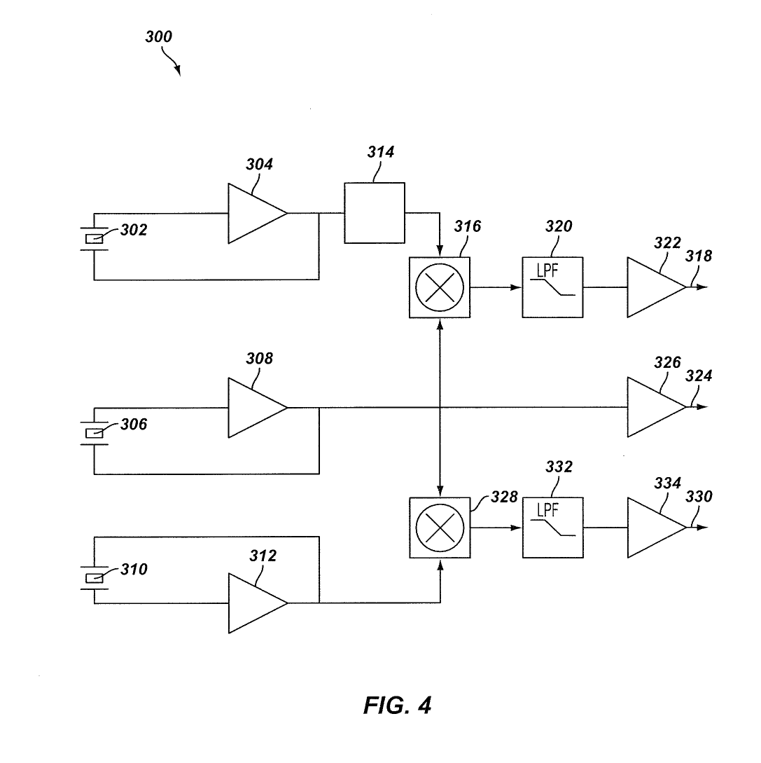

FIG. 4 is a schematic block diagram of a circuit 300 suitable for use with transducers (e.g., the electronics assembly 120 of the pressure transducer 100 (FIG. 1)) and sensors (e.g., pressure and/or temperature sensor 200 (FIGS. 2 and 3)). In particular, circuit 300 may be particularly suited for use with the resonator sensor 200 having a relatively smaller outer diameter than similar conventional sensors and transducers including such sensors 200. The relatively smaller outer dimension D₂₀₁ of resonator sensor 200 may dictate the overall size of the resonator element 202 and resonating portion 210 of the resonator element 202. In other words, the relatively smaller outer dimension D₂₀₁ of resonator sensor 200 may require the resonator element 202 and resonating portion 210 of the resonator element 202 to be reduced.

In some embodiments, such a relatively smaller resonator element 202 and resonating portion 210 thereof will require an electronics assembly (e.g., electronics assembly 120) having circuitry capable of providing the relatively higher frequencies output by the resonator element 202. For example, a transducer (e.g., the pressure transducer 100) including one or more resonator sensors 200 and, optionally, one or more other conventional resonator sensors includes an electronics assembly (e.g., electronics assembly 120) having one or more of the circuits discussed below to enable the electronics assembly of the transducer to operate the various resonator sensors of the transducer (e.g., to drive the sensor via an amplifier and receive a frequency response therefrom).

As shown in FIG. 4, the circuit 300 includes a first oscillator having a first resonator 302 (e.g., a crystal resonator) driven by a first amplifier 304. The first amplifier 304 drives the first resonator 302 (e.g., at relatively higher frequency) to provide a sensor for measuring a pressure and/or temperature (e.g., resonator sensor 200 (FIGS. 2 and 3) for measuring pressure). The first amplifier 304 may drive the first resonator 302 at a relatively higher frequency such as, for example, over 14 MHz (e.g., about 14.45 MHz).

The circuit 300 includes a second oscillator having a second resonator 306 (e.g., a crystal resonator) driven by a second amplifier 308. The second amplifier 308 drives the second resonator 306 (e.g., at a frequency lower than the first resonator 302 and the first amplifier 304) to provide a reference sensor (e.g., reference sensor 116 (FIG. 1)). The second amplifier 308 may drive the second resonator 306 at a relatively lower frequency such as, for example, about 7 MHz (e.g., about 7.2 MHz).

In some embodiments, the circuit 300 includes a third oscillator having a third resonator 310 (e.g., a crystal resonator) driven by a third amplifier 312. The third amplifier 312 drives the third resonator 310 (e.g., at a frequency lower than the first resonator 302 and the first amplifier 304) to provide a temperature sensor (e.g., temperature sensor 112 (FIG. 1)). As discussed above, in some embodiments, one resonator sensor may be configured as a dual-mode resonator sensor for acting as both the pressure sensor and the temperature sensor. The third amplifier 312 may drive the third resonator 310 at a relatively lower frequency such as, for example, about 7 MHz (e.g., about 7.15 MHz).

The relatively higher frequency signal produced by the first resonator 302 may be sent to a frequency divider 314 (e.g., a pressure-related frequency response) where the relatively higher frequency signal may be altered to be closer in value to the relatively lower frequency signals produced by one or more of the second resonator 306 (e.g., a reference frequency response) and the third resonator 310 (e.g., a temperature-related frequency response). For example, the relatively higher frequency signal produced by the first resonator 302 may be reduced (e.g., by half, by a third, etc.) by the frequency divider 314 and sent to mixer 316 to be combined with the signal of the reference sensor generated by the second resonator 306.

The two, now relatively lower frequency signals from the first resonator 302 and the second resonator 306 (e.g., two frequency signals created by driving the pressure sensor and reference sensor) may be mixed by mixer 316, which creates a sum of the signals and a difference of the signals, and the resultant signal is sent to output 318 (e.g., pressure output) via a filter 320 (e.g., a low-pass filter) and amplifier 322. For example, the sum of the two frequency signals may be filtered by the low-pass filter 320 and the difference of the two frequency signals (e.g., a signal having in a value in the kilohertz range (i.e., below 1 MHz))) may be utilized to calculate the pressure at the output 318.

The frequency signal produced by the second resonator 306 (e.g., the frequency signal created by driving the reference sensor) may also be sent to output 324 (e.g., reference output) via amplifier 326.

The frequency signals produced by the second resonator 306 and the third resonator 310 (e.g., two frequency signals created by driving the reference sensor and temperature sensor) may be mixed by mixer 328, which creates a sum of the signals and a difference of the signals, and the resultant signal is sent to output 330 (e.g., temperature output) via a filter 332 (e.g., a low-pass filter) and amplifier 334. For example, the sum of the two frequency signals may be filtered by the low-pass filter 332 and the difference of the two frequency signals (e.g., a signal having in a value in the kilohertz range (i.e., below 1 MHz))) may be utilized to calculate the temperature at the output 330.

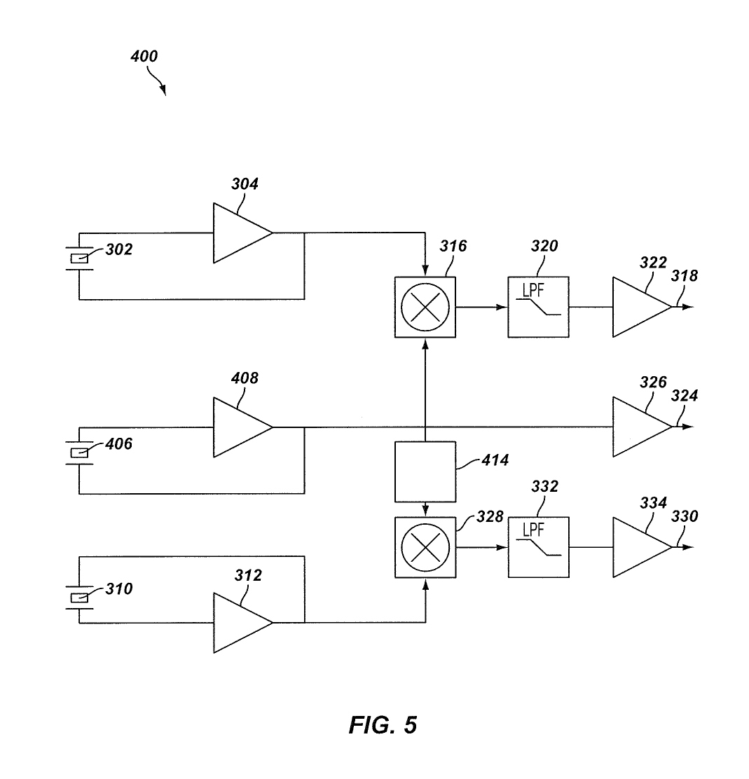

FIG. 5 is a schematic block diagram of a circuit 400 suitable for use with transducers (e.g., the electronics assembly 120 of the pressure transducer 100) and sensors (e.g., pressure and/or temperature sensor 200). In some embodiments, circuit 400 may be somewhat similar to circuit 300 described above with reference to FIG. 4 and may be particularly suited for use with resonator sensor 200 having a relatively smaller outer diameter than similar conventional sensors and transducers including such sensors 200. However, as shown in FIG. 5 and discussed below, both the first resonator 302 and a second resonator 406 (e.g., a crystal resonator) may be selected to produce a relatively higher frequency signal and a frequency divider 414 may be positioned such that the relatively higher signal from the second resonator 406 is divided before being mixed with the signal from the third resonator 310.

As shown in FIG. 5, the circuit 400 includes the first resonator 302 driven by the first amplifier 304 at a relatively higher frequency such as, for example, over 14 MHz (e.g., about 14.45 MHz) to provide the pressure sensor.

The circuit 400 includes the second resonator 406 driven by a second amplifier 408 (e.g., at a relatively higher frequency similar to the first resonator 302 and the first amplifier 304) to provide a reference sensor (e.g., reference sensor 116 (FIG. 1)). The second amplifier 408 may drive the second resonator at a relatively higher frequency such as, for example, over 14 MHz (e.g., about 14.4 MHz).

In some embodiments, the circuit 400 includes the third resonator 310 driven by the third amplifier 312 at a relatively lower frequency such as, for example, about 7 MHz (e.g., about 7.15 MHz) to provide the temperature sensor.

The two, now relatively higher frequency signals from the first resonator 302 and the second resonator 406 (e.g., two frequency signals created by driving the pressure sensor and reference sensor) may be mixed by mixer 316, which creates a sum of the signals and a difference of the signals, and the resultant signal is sent to output 318 (e.g., pressure output) via a filter 320 (e.g., a low-pass filter) and amplifier 322. For example, the sum of the two frequency signals may be filtered by the low-pass filter 320 and the difference of the two frequency signals (e.g., a signal having in a value in the kilohertz range (i.e., below 1 MHz))) may be utilized to calculate the pressure at the output 318.

The relatively higher frequency signal produced by the second resonator 406 (e.g., the frequency signal created by driving the reference sensor) may also be sent to output 324 (e.g., reference output) via amplifier 326.

The relatively higher frequency signal produced by the second resonator 406 may be sent to a frequency divider 414 where the relatively higher frequency signal may be altered to be closer in value to the relatively lower frequency signals produced by the third resonator 310. For example, the relatively higher frequency signal produced by the second resonator 406 may be reduced (e.g., by half, by a third, etc.) by the frequency divider 414 and sent to mixer 328 to be combined with the signal of the temperature sensor generated by the third resonator 310.

The frequency signals produced by the second resonator 406 and the third resonator 310 (e.g., two frequency signals created by driving the reference sensor and temperature sensor) may be mixed by mixer 328, which creates a sum of the signals and a difference of the signals, and the resultant signal is sent to output 330 (e.g., temperature output) via a filter 332 (e.g., a low-pass filter) and amplifier 334. For example, the sum of the two frequency signals may be filtered by the low-pass filter 332 and the difference of the two frequency signals (e.g., a signal having in a value in the kilohertz range (i.e., below 1 MHz))) may be utilized to calculate the temperature at the output 330.

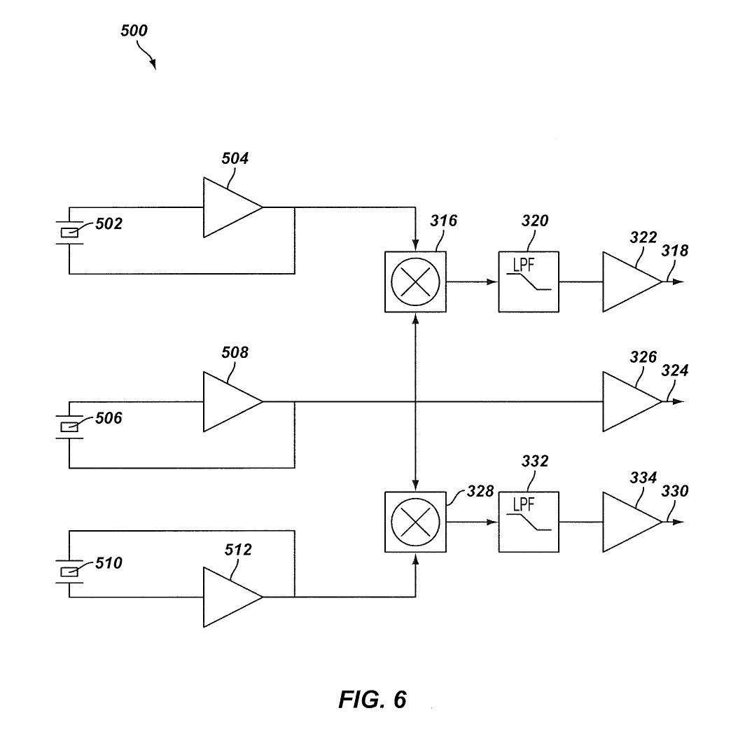

FIG. 6 is a schematic block diagram of a circuit 500 suitable for use with transducers (e.g., the electronics assembly 120 of the pressure transducer 100) and sensors (e.g., pressure and/or temperature sensor 200. In some embodiments, circuit 500 may be somewhat similar to circuit 300 described above with reference to FIG. 4 and may be particularly suited for use with resonator sensor 200 having a relatively smaller outer diameter than similar conventional sensors and transducers including such sensors 200. However, as shown in FIG. 6 and discussed below, a first resonator 502, a second resonator 506, and a third resonator 510 may each be selected to produce a relatively higher frequency signal (e.g., over 14 MHz).

As shown in FIG. 6, the circuit 500 includes the first resonator 502 driven by a first amplifier 504 for driving at a relatively higher frequency such as, for example, over 14 MHz (e.g., about 14.45 MHz) to provide the pressure sensor.

The circuit 500 includes the second resonator 506 driven by a second amplifier 508 (e.g., at a relatively higher frequency similar to the first resonator 502) to provide the reference sensor. The second amplifier 508 may drive the second resonator 506 at a relatively higher frequency such as, for example, over 14 MHz (e.g., about 14.4 MHz).

In some embodiments, the circuit 500 includes the third resonator 510 driven by a third amplifier 512 (e.g., at a relatively higher frequency similar to the first resonator 502 and the second resonator 506) to provide the temperature sensor. The third amplifier 512 may drive the third resonator 510 at a relatively higher frequency such as, for example, over 14 MHz (e.g., about 14.35 MHz).

The two, relatively higher frequency signals produced by the first resonator 502 and the second resonator 506 (e.g., two frequency signals created by driving the pressure sensor and reference sensor) may be mixed by mixer 316, which creates a sum of the signals and a difference of the signals, and the resultant signal is sent to output 318 (e.g., pressure output) via a filter 320 (e.g., a low-pass filter) and amplifier 322. For example, the sum of the two frequency signals may be filtered by the low-pass filter 320 and the difference of the two frequency signals (e.g., a signal having in a value in the kilohertz range (i.e., below 1 MHz))) may be utilized to calculate the pressure at the output 318.

The relatively higher frequency signal produced by the second resonator 506 (e.g., the frequency signal created by driving the reference sensor) may also be sent to output 324 (e.g., reference output) via amplifier 326.

The two, relatively higher frequency signals produced by the second resonator 506 and the third resonator 510 (e.g., two frequency signals created by driving the reference sensor and temperature sensor) may be mixed by mixer 328, which creates a sum of the signals and a difference of the signals, and the resultant signal is sent to output 330 (e.g., temperature output) via a filter 332 (e.g., a low-pass filter) and amplifier 334. For example, the sum of the two frequency signals may be filtered by the low-pass filter 332 and the difference of the two frequency signals (e.g., a signal having in a value in the kilohertz range (i.e., below 1 MHz))) may be utilized to calculate the temperature at the output 330.

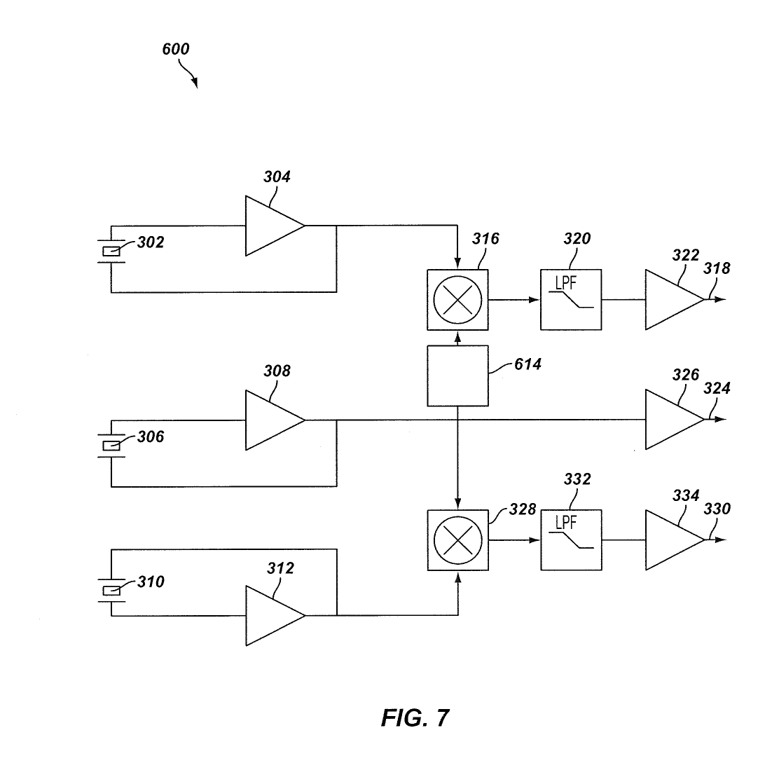

FIG. 7 is a schematic block diagram of a circuit 600 suitable for use with transducers (e.g., the electronics assembly 120 of the pressure transducer 100) and sensors (e.g., pressure and/or temperature sensor 200. In some embodiments, circuit 600 may be somewhat similar to circuit 300 described above with reference to FIG. 4 and may be particularly suited for use with resonator sensor 200 having a relatively smaller outer diameter than similar conventional sensors and transducers including such sensors 200. However, as shown in FIG. 7 and discussed below, a frequency doubler 614 may be positioned such that the relatively lower frequency signal from the second resonator 306 is multiplied before being mixed with the relatively higher signal from the first resonator 302.

As shown in FIG. 7, the circuit 600 includes the first resonator 302 driven by the first amplifier 304 at a relatively higher frequency such as, for example, over 14 MHz (e.g., about 14.45 MHz) to provide the pressure sensor.

The circuit 600 includes the second resonator 306 driven by the second amplifier 308 at a relatively lower frequency such as, for example, about 7 MHz (e.g., about 7.2 MHz) to provide the temperature sensor.

In some embodiments, the circuit 600 includes the third resonator 310 driven by the third amplifier 312 at a relatively lower frequency such as, for example, about 7 MHz (e.g., about 7.15 MHz) to provide the temperature sensor.

The relatively lower frequency signal produced by the second resonator 306 may be sent to a frequency doubler 614 where the relatively lower frequency signal may be altered to be closer in value to the relatively higher frequency signal produced by the first resonator 302. For example, the relatively lower frequency signal produced by the second resonator 306 may be multiplied (e.g., by two times, by three times, etc.) by the frequency doubler 614 and sent to mixer 316 to be combined with the signal of the pressure sensor generated by the second resonator 302.

The two, now relatively higher frequency signals from the first resonator 302 and the second resonator 306 (e.g., two frequency signals created by driving the pressure sensor and reference sensor) may be mixed by mixer 316, which creates a sum of the signals and a difference of the signals, and the resultant signal is sent to output 318 (e.g., pressure output) via a filter 320 (e.g., a low-pass filter) and amplifier 322. For example, the sum of the two frequency signals may be filtered by the low-pass filter 320 and the difference of the two frequency signals (e.g., a signal having in a value in the kilohertz range (i.e., below 1 MHz))) may be utilized to calculate the pressure at the output 318.

The frequency signal produced by the second resonator 306 (e.g., the frequency signal created by driving the reference sensor) may also be sent to output 324 (e.g., reference output) via amplifier 326.

The frequency signals produced by the second resonator 306 and the third resonator 310 (e.g., two frequency signals created by driving the reference sensor and temperature sensor) may be mixed by mixer 328, which creates a sum of the signals and a difference of the signals, and the resultant signal is sent to output 330 (e.g., temperature output) via a filter 332 (e.g., a low-pass filter) and amplifier 334. For example, the sum of the two frequency signals may be filtered by the low-pass filter 332 and the difference of the two frequency signals (e.g., a signal having in a value in the kilohertz range (i.e., below 1 MHz))) may be utilized to calculate the temperature at the output 330.

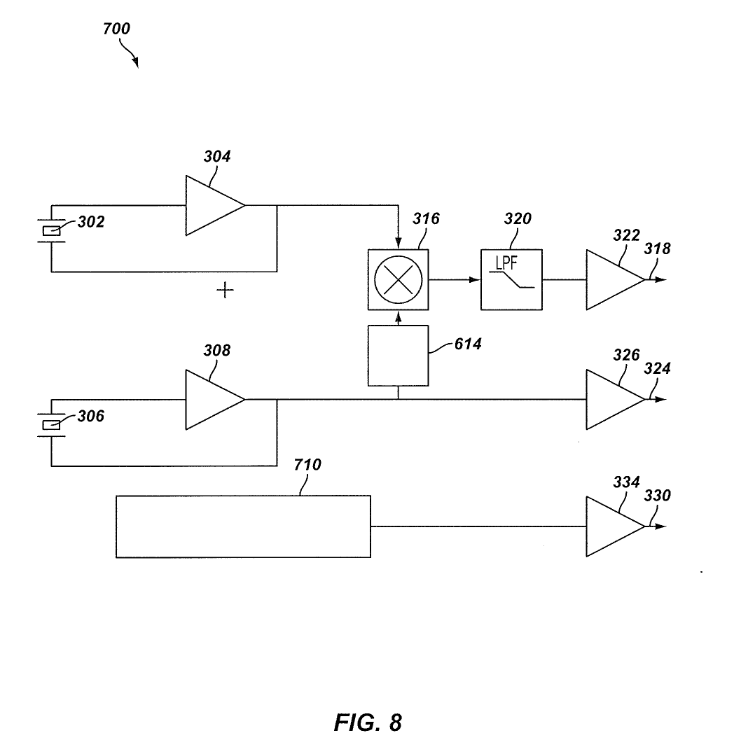

FIG. 8 is a schematic block diagram of a circuit 600 suitable for use with transducers (e.g., the electronics assembly 120 of the pressure transducer 100) and sensors (e.g., pressure and/or temperature sensor 200. In some embodiments, circuit 600 may be somewhat similar to circuits 300, 500, 600 described above with reference to FIGS. 4, 6, and 7 and may be particularly suited for use with resonator sensor 200 having a relatively smaller outer diameter than similar conventional sensors and transducers including such sensors 200. However, as shown in FIG. 8 and discussed below, the circuit 700 may include an electronic temperature sensor 710 (e.g., a silicon temperature sensor as disclosed in the above-incorporated U.S. patent application Ser. No. 13/934,058) rather than a resonator sensor.

As shown in FIG. 8, the circuit 700 includes the first resonator 302 driven by the first amplifier 304 at a relatively higher frequency such as, for example, over 14 MHz (e.g., about 14.45 MHz) to provide the pressure sensor.

The circuit 700 includes the second resonator 306 driven by the second amplifier 308 at a relatively lower frequency such as, for example, about 7 MHz (e.g., about 7.2 MHz) to provide the reference sensor. In other embodiments, the second resonator (e.g., second resonator 406) may drive the reference sensor at a relatively higher frequency such as, for example, over 14 MHz (e.g., about 14.4 MHz).

The circuit 700 includes an electronic temperature sensor 710 for electronic measurement of temperature (e.g., a sensor utilizing integrated electronic circuits to monitor temperature rather than a sensor exhibiting temperature-dependent variable mechanical characteristics such as a quartz crystal resonator).

The relatively lower frequency signal produced by the second resonator 306 may be sent to a frequency doubler 614 where the relatively lower frequency signal may be altered to be closer in value to the relatively higher frequency signal produced by the first resonator 302. For example, the relatively lower frequency signal produced by the second resonator 306 may be multiplied (e.g., by two times, by three times, etc.) by the frequency doubler 614 and sent to mixer 316 to be combined with the signal of the pressure sensor generated by the second resonator 302. In other embodiments, a frequency divider may be utilized on the relatively higher frequency signal produced by the first resonator 302.

The two, now relatively higher frequency signals from the first resonator 302 and the second resonator 306 (e.g., two frequency signals created by driving the pressure sensor and reference sensor) may be mixed by mixer 316, which creates a sum of the signals and a difference of the signals, and the resultant signal is sent to output 318 (e.g., pressure output) via a filter 320 (e.g., a low-pass filter) and amplifier 322. For example, the sum of the two frequency signals may be filtered by the low-pass filter 320 and the difference of the two frequency signals (e.g., a signal having in a value in the kilohertz range (i.e., below 1 MHz))) may be utilized to calculate the pressure at the output 318.

The frequency signal produced by the second resonator 306 (e.g., the frequency signal created by driving the reference sensor) may also be sent to output 324 (e.g., reference output) via amplifier 326.

The temperature signal produced by the electronic temperature sensor 710 is sent to output 330 (e.g., temperature output).

Embodiments of the present disclosure may be particularly useful in providing relatively smaller sensors having a robust applicability in many different applications. In downhole applications, relatively smaller sensors enable the overall size of a transducer assembly to be reduced, enabling more efficient production of current, smaller wellbore diameter wells as well as exploration of new, more challenging formations using so-called “slimhole” drilling techniques with small diameter drilling strings and bottomhole components. For example, relatively smaller transducers also enable the ability to pass wires past the transducer between components above and below such transducers when disposed in a drill sting in ways that were not possible before with conventional sized transducers. Furthermore, smaller sensors are also believed to reach thermal equilibrium faster, resulting in less pressure measurement error while temperature is variable or during a transient temperature event. When implemented as a pressure sensor in a pressure transducer, the relatively smaller pressure sensor is closer in size to the temperature crystal, resulting in more similar responses to temperature change. Additionally, temperature gradients within the pressure sensor which may cause stress within the sensor that changes the natural frequencies of the pressure sensor and leads to pressure measurement error may be reduced.

While the disclosure may be susceptible to various modifications and alternative forms, specific embodiments have been shown by way of example in the drawings and have been described in detail herein. However, it should be understood that the disclosure is not intended to be limited to the particular foams disclosed. Rather, the disclosure encompasses all modifications, variations, combinations, and alternatives falling within the scope of the disclosure as defined by the following appended claims and their legal equivalents.

What is claimed is:

1. A thickness shear mode resonator pressure sensor, comprising:
a housing having a longitudinal axis, the housing comprising:
a resonator element having a resonating portion;
a first end cap forming first recess between a first side of the resonating portion of the resonator and the first end cap; and
a second end cap forming second recess between a second side of the resonating portion of the resonator and the first end cap;
wherein an outer dimension of the housing taken in direction transverse to the longitudinal axis of the housing is less than 0.575 inch (14.605 millimeters).

2. The thickness shear mode resonator pressure sensor of claim 1, wherein the outer dimension of the housing comprises a maximum outer diameter of the housing.

3. The thickness shear mode resonator pressure sensor of claim 1, wherein the outer dimension of the housing is between about 0.30 inch (7.62 millimeters) and about 0.50 inch (12.7 millimeters).

4. The thickness shear mode resonator pressure sensor of claim 3, wherein the outer dimension of the housing is about 0.375 inch (9.525 millimeters).

5. The thickness shear mode resonator pressure sensor of claim 1, wherein the outer dimension of the housing is between about 0.30 inch (7.62 millimeters) and about 0.40 inch (10.16 millimeters).

6. A quartz resonator pressure transducer assembly, comprising:
a pressure housing comprising at least one chamber;
an electronics housing comprising an electronics assembly;
a quartz pressure sensor in communication with the at least one chamber and configured for measuring pressure of a fluid disposed within the at least one chamber, wherein the electronics assembly is configured to drive the quartz pressure sensor at a selected frequency and to sense a pressure-related frequency response from the quartz pressure sensor; and
a quartz reference sensor, wherein the electronics assembly is configured to drive the quartz reference sensor at a selected frequency and to sense a reference frequency response from the quartz reference sensor, and wherein the electronics assembly is configured to drive at least one of the quartz pressure sensor and the quartz reference sensor at a frequency greater than 10 MHz.

7. The quartz resonator pressure transducer assembly of claim 6, wherein the electronics assembly is configured to drive at least one of the quartz pressure sensor and the quartz reference sensor at a frequency greater than 14 MHz.

8. The quartz resonator pressure transducer assembly of claim 6, wherein an outer dimension of the pressure transducer assembly is less than 0.75 inch (19.05 millimeters).

9. The quartz resonator pressure transducer assembly of claim 8, wherein an outer dimension of the pressure transducer assembly is between 0.40 inch (10.16 millimeters) and 0.60 inch (15.24 millimeters).

10. The quartz resonator pressure transducer assembly of claim 6, wherein the electronics assembly is configured to divide the pressure-related frequency response from the quartz pressure sensor before mixing the pressure-related frequency response with the reference frequency response from the quartz reference sensor.

11. The quartz resonator pressure transducer assembly of claim 10, wherein the electronics assembly is configured to divide the pressure-related frequency response from the quartz pressure sensor by two.

12. The quartz resonator pressure transducer assembly of claim 6, wherein the electronics assembly is configured to multiply the reference frequency response from the quartz pressure sensor before mixing the reference frequency response from the quartz reference sensor with the pressure-related frequency response.

13. The quartz resonator pressure transducer assembly of claim 12, wherein the electronics assembly is configured to multiply the reference frequency response from the quartz pressure sensor by two.

14. The quartz resonator pressure transducer assembly of claim 6, wherein the electronics assembly is configured to drive both the quartz pressure sensor and the quartz reference sensor at a frequency greater than 14 MHz.

15. The quartz resonator pressure transducer assembly of claim 6, further comprising a temperature sensor electrically coupled to the electronics assembly and configured to output a temperature signal to the electronics assembly.

16. The quartz resonator pressure transducer assembly of claim 15, wherein the electronics assembly is configured to divide the reference frequency response from the quartz reference sensor before mixing the reference frequency response from the quartz reference sensor with a temperature frequency response from the temperature sensor.

17. The quartz resonator pressure transducer assembly of claim 15, wherein the temperature sensor comprises an electronic temperature sensor.

18. The quartz resonator pressure transducer assembly of claim 17, wherein the electronic temperature sensor comprises a proportional to absolute temperature (PTAT) current generator configured to generate a PTAT current, the electronic temperature sensor configured to convert the PTAT current to a temperature frequency response and output the temperature frequency response to the electronics assembly.

19. The quartz resonator pressure transducer assembly of claim 15, wherein the temperature sensor comprises a quartz temperature sensor, wherein the electronics assembly is configured to drive the quartz temperature sensor at a selected frequency and to sense a temperature-related frequency response from the quartz temperature sensor, and wherein the electronics assembly is configured to drive the quartz pressure sensor, the quartz reference sensor, and quartz temperature sensor at a frequency greater than 14 MHz.

20. A quartz resonator pressure transducer assembly, comprising:
a pressure housing comprising at least one chamber;
an electronics housing comprising an electronics assembly; and
a quartz pressure sensor in communication with the at least one chamber and configured for measuring pressure of a fluid disposed within the at least one chamber, wherein the electronics assembly is configured to drive the quartz pressure sensor at a selected frequency and to sense a pressure-related frequency response from the quartz pressure sensor, wherein an outer dimension of the pressure transducer assembly is less than 0.75 inch (19.05 millimeters).

21. A transducer assembly wherein an electronics assembly of the transducer assembly is configured to drive at least one quartz sensor of the transducer assembly at a frequency greater than 10 MHz.
